(19) United States
(12) Patent Application Publication
(10) Pub. No.: US 2024/0163903 A1
(43) Pub. Date: May 16, 2024

(54) METHODS AND APPARATUSES FOR A RESOURCE CONFLICT INDICATOR TRANSMISSION

(71) Applicant: Lenovo (Beijing) Limited, Beijing (CN)

(72) Inventors: Zhennian Sun, Beijing (CN); Xiaodong Yu, Beijing (CN); Haipeng Lei, Beijing (CN); Xin Guo, Beijing (CN)

(73) Assignee: Lenovo (Beijing) Limited, Beijing (CN)

(21) Appl. No.: 18/282,657

(22) PCT Filed: Mar. 19, 2021
(86) PCT No.: PCT/CN2021/081763

§ 371 Date: Sep. 18, 2023

(51) Int. Cl. H04W 72/25; H04W 72/02; H04W 72/0446

(52) U.S. Cl. CPC H04W 72/25; H04W 72/02; H04W 72/0446; H04W 92/18

(57) ABSTRACT

Embodiments of the present disclosure relate to methods and apparatuses for a resource conflict indicator transmission in a sidelink wireless communication system in 3GPP (3rd Generation Partnership Project) 5G networks. According to an embodiment of the present disclosure, a method performed by a user equipment (UE) includes: receiving two or more control signals from two or more UEs, wherein one control signal received from each UE within the two or more UEs indicates one or more reserved resources for the each UE; detecting whether there is a resource conflict among reserved resources for the two or more UEs; upon detecting the resource conflict, selecting a transmission resource from a set of resources, wherein each resource within the set of resources is used for a resource conflict indictor transmission; and transmitting, to at least one UE within the two or more UEs, a resource conflict indictor on the selected transmission resource.

### TECHNICAL FIELD

Embodiments of the present application are related to wireless communication technology, and more particularly, related to methods and apparatuses for a resource conflict indicator transmission in a sidelink wireless communication system in 3GPP (3rd Generation Partnership Project) 5G networks.

### BACKGROUND

A sidelink is a long-term evolution (LTE) feature introduced in 3GPP Release 12, and enables a direct communication between proximal UEs, and data does not need to go through a base station (BS) or a core network. A sidelink communication system has been introduced into 3GPP 5G wireless communication technology, in which a direct link between two user equipments (UEs) is called a sidelink.

3GPP 5G networks are expected to increase network throughput, coverage, and robustness and reduce latency and power consumption. With the development of 3GPP 5G networks, various aspects need to be studied and developed to perfect the 5G technology. Currently, details regarding a resource conflict indicator transmission in a sidelink wireless communication system have not been discussed in 3GPP 5G technology yet.

### SUMMARY

Some embodiments of the present application provide a method, which may be performed by a user equipment (UE). The method includes: receiving two or more control signals from two or more UEs, wherein one control signal received from each UE within the two or more UEs indicates one or more reserved resources for the each UE; detecting whether there is a resource conflict among reserved resources for the two or more UEs; upon detecting the resource conflict, selecting a transmission resource from a set of resources, wherein each resource within the set of resources is used for a resource conflict indictor transmission; and transmitting, to at least one UE within the two or more UEs, a resource conflict indictor on the selected transmission resource.

Some embodiments of the present application provide a further method, which may be performed by a UE. The method includes: transmitting a control signal to a second UE, wherein the control signal indicates one or more reserved resources for the first UE; and receiving a resource conflict indicator from the second UE, wherein the resource conflict indicator indicates that there is a resource conflict between the one or more reserved resources for the first UE and one or more reserved resources for a third UE.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement any of the abovementioned methods performed by a UE.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 illustrates an exemplary sidelink wireless communication system in accordance with some embodiments of the present application;

FIG. 2 illustrates an exemplary flow chart of a method for receiving a resource conflict indicator according to some embodiments of the present application;

FIG. 3 illustrates an exemplary flow chart of a method for transmitting a resource conflict indicator on a transmission resource according to some embodiments of the present application;

FIG. 4 illustrates an exemplary diagram for sets of resource conflict indicator transmission resources according to some embodiments of the present application;

FIG. 5 illustrates a further exemplary diagram for sets of resource conflict indicator transmission resources according to some embodiments of the present application;

FIG. 6 illustrates another exemplary diagram for sets of resource conflict indicator transmission resources according to some embodiments of the present application;

FIG. 7 illustrates an additional exemplary diagram for sets of resource conflict indicator transmission resources according to some embodiments of the present application;

FIG. 8 illustrates yet an additional exemplary diagram for sets of resource conflict indicator transmission resources according to some embodiments of the present application;

FIG. 9 illustrates yet an additional exemplary diagram for sets of resource conflict indicator transmission resources according to some embodiments of the present application;

FIG. 10 illustrates yet an additional exemplary diagram for sets of resource conflict indicator transmission resources according to some embodiments of the present application;

FIG. 11 illustrates yet an additional exemplary diagram for sets of resource conflict indicator transmission resources according to some embodiments of the present application;

FIG. 12 illustrates yet an additional exemplary diagram for sets of resource conflict indicator transmission resources according to some embodiments of the present application; and

FIG. 13 illustrates an exemplary block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8, B5G, 6G, and so on. It is contemplated that along with developments of network architectures and new service scenarios, all embodiments in the present application are also applicable to similar technical problems; and moreover, the terminologies recited in the present application may change, which should not affect the principle of the present application.

In a sidelink communication system, a transmission UE may also be named as a transmitting UE, a Tx UE, a sidelink Tx UE, a sidelink transmission UE, or the like. A reception UE may also be named as a receiving UE, a Rx UE, a sidelink Rx UE, a sidelink reception UE, or the like.

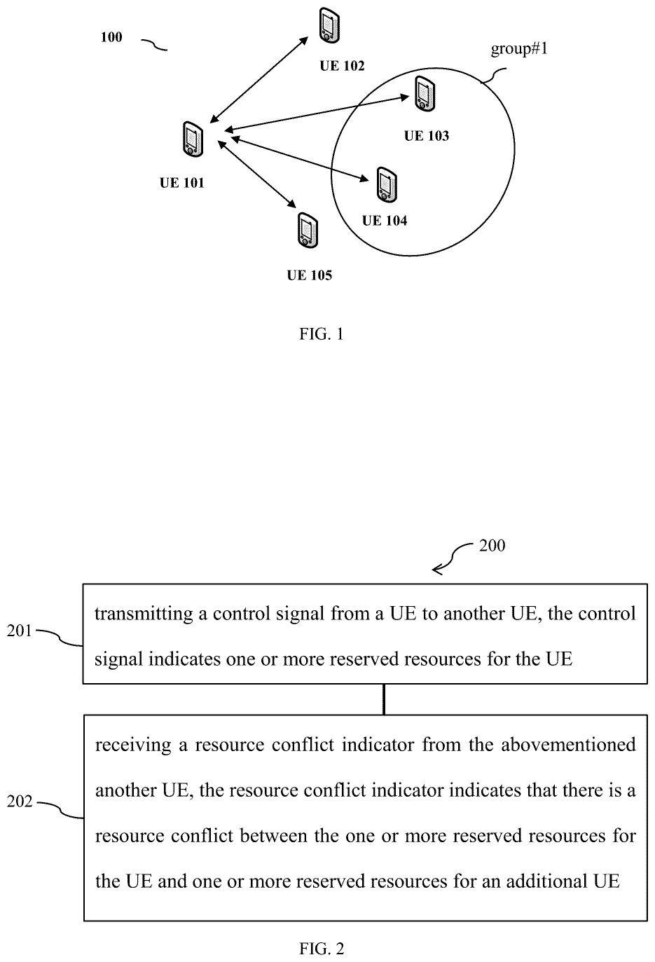

FIG. 1 illustrates an exemplary sidelink wireless communication system in accordance with some embodiments of the present application.

As shown in FIG. 1, a sidelink wireless communication system 100 includes at least five user equipments (UEs), including one Tx UE (i.e., UE 101 as shown in FIG. 1) and four Rx UEs (i.e., UE 102, UE 103, UE 104, and UE 105 as shown in FIG. 1), for illustrative purpose. Although a specific number of UEs are depicted in FIG. 1, it is contemplated that any number of UE(s) (e.g., Tx UE(s) or Rx UE(s)) may be included in the sidelink wireless communication system 100.

The sidelink transmission implemented in the wireless communication system 100 of the embodiments of FIG. 1 includes unicast transmission, groupcast transmission, and broadcast transmission. For example, UE 102 and UE 105 represent Rx UEs for unicast transmission. UE 103 and UE 104 may form group #1 as shown in FIG. 1. In one example, group #1 may correspond to a sidelink groupcast session for groupcast transmission. UE 101 may transmit data to UE 103 and UE 104 in group #1 through a sidelink groupcast session. In a further example, group #1 may correspond to a sidelink broadcast session for broadcast transmission. UE 101 may transmit data to UE 103 and UE 104 in group #1 through a sidelink broadcast session.

Each UE in FIG. 1 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present application, a UE in FIG. 1 may include a portable wireless communication device, a smart phone, a cellular telephone, a flip phone, a device having a subscriber identity module, a personal computer, a selective call receiver, or any other device that is capable of sending and receiving communication signals on a wireless network.

In some embodiments of the present application, a UE in FIG. 1 is a pedestrian UE (P-UE or PUE) or a cyclist UE. In some embodiments of the present application, a UE in FIG. 1 includes wearable devices, such as smart watches, fitness bands, optical head-mounted displays, or the like. Moreover, a UE in FIG. 1 may be referred to as a subscriber unit, a mobile, a mobile station, a user, a terminal, a mobile terminal, a wireless terminal, a fixed terminal, a subscriber station, a user terminal, or a device, or described using other terminology used in the art. A UE in FIG. 1 may communicate directly with a base station (BS) via LTE or NR Uu interface.

In some embodiments of the present application, each UE in FIG. 1 may be deployed an IoT application, an enhanced mobile broadband (eMBB) application and/or an ultra-reliable and low latency communication (URLLC) application. For instance, UE 101 may implement an IoT application and may be named as an IoT UE, while UE 102 may implement an eMBB application and/or a URLLC application and may be named as an eMBB UE, an URLLC UE, or an eMBB/URLLC UE. It is contemplated that the specific type of application(s) deployed in the UE in FIG. 1 may be varied and not limited.

According to some embodiments of FIG. 1, a UE may exchange sidelink messages with another UE(s) through a sidelink, for example, PC5 interface as defined in 3GPP standard document TS23.303. The UE may transmit information or data to another UE(s) within the sidelink communication system, through sidelink unicast, sidelink groupcast, or sidelink broadcast.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) (not shown in FIG. 1) transmit data using an OFDM modulation scheme on the downlink (DL) and the UE(s) in FIG. 1 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

Currently, two sidelink resource allocation modes are supported, i.e., Mode 1 and Mode 2. In Mode 1, sidelink resource(s) in time and frequency domains allocation is provided by a network or a BS. In Mode 2, a UE decides sidelink transmission resource(s) in time and frequency domains in a resource pool. According to agreements of 3GPP RAN1 meeting, an inter-UE coordination in Mode 2 is feasible and beneficial (e.g., reliability, etc.) compared to Release 16 Mode 2 resource allocation.

Referring back to FIG. 1, in particular, a UE within UE 102 to UE 105 (which may also function as a Tx UE) may transmit trigger information or coordination information to UE 101 (which may function as a coordination UE). UE 101 may work with sidelink resource allocation Mode 1 or Mode 2. A candidate receiver may also be named as an intended receiver, a targeted receiver, a candidate receiving UE, a candidate Rx UE, or the like. UE 101 may transmit information regarding a set of resources in time domain and/or frequency domain to the UE within UE 102 to UE 105.

In general, three types of inter-UE coordination schemes have been evaluated and studied in 3GPP RAN1 meeting in the following categories:
(1) Type A: UE-A (e.g., UE 101 illustrated and shown in FIG. 1) sends to UE-B (e.g., any of UE 102 to UE 105 illustrated and shown in FIG. 1) a set of resources preferred for UE-B's transmission, e.g., based on its sensing result.
(2) Type B: UE-A sends to UE-B a set of resources not preferred for UE-B's transmission, e.g., based on its sensing result and/or expected/potential resource conflict.
(3) Type C: UE-A sends to UE-B a set of resources where the resource conflict is detected.

For Type C inter-UE coordination (UE-A sends to UE-B the set of resources where the resource conflict is detected), physical sidelink feedback channel (PSFCH) resources is proposed to be used to transmit the collision indicator. For example, collision and conflict indications need to be transmitted with a low delay, so that the UE-s receiving the indication can have sufficient time to react to it either by scheduling a retransmission or reselection future resources. Thus, it is beneficial to transmit them over the PSFCH. This could be either using the PSFCH resources not used for feedback transmissions, or using the ones used for PSFCH transmission and associated with one or all the UE-s involved in the conflict. Using PSFCH resources does not limit the applicability of conflict indicators to only transmissions with feedback. The same mapping rules between a transmission and its PFSCH can be in such cases, e.g., broadcast. It is also proposed that when PSFCH is used to indicate half duplex and post collision, in order to have a gain, multiple PSFCH should be transmitted simultaneously. The power of UE-A is enough or not should be considered.

Currently, details regarding how to identify whether a resource conflict will happen, e.g., based on what resource conflict check conditions, and how to select a resource for a resource conflict indicator transmission have not been discussed in 3GPP 5G technology yet. Embodiments of the present application define specific alternatives to address the above issues on a resource conflict indicator transmission for different cases.

Some embodiments of the present application define resource conflict conditions. In an embodiment, received sidelink control information (SCI) with overlapped reserved resources should be detected within one time window “L”; and then, Type-C inter-UE coordination will be triggered or a resource conflict indicator transmission will be performed. In a further embodiment, different resource conflict conditions may be checked for different total number of reserved resources. Some embodiments of the present application define a UE's behaviours after receiving a resource conflict indicator.

Some embodiments of the present application define resource conflict indicator transmission resource(s) and/or PSFCH resource selection scheme(s). A resource conflict indicator transmission resource may also be named as “a resource conflict indicator resource”, “a resource conflict indication resource”, “a transmission resource for a resource conflict indicator”, “a resource for transmitting a resource conflict indicator”, “a resource for a resource conflict indicator transmission”, or the like.

In particular, for some cases, a UE may select a resource associated with a UE′ transmission having a lower priority, as a resource conflict indicator transmission resource. For some cases, a UE may select the first resource in time domain as a resource conflict indicator transmission resource, to reduce a delay of inter-UE coordination. For some cases, a UE may select a resource associated with less reserved resources in time domain of a UE, as a resource conflict indicator transmission resource. For some cases, a UE may select a resource associated with less reserved sub-channels of a UE, as a resource conflict indicator transmission resource. More details will be illustrated in the following text in combination with the appended drawings.

FIG. 2 illustrates an exemplary flow chart of a method for receiving a resource conflict indicator according to some embodiments of the present application. The embodiments of FIG. 2 may be performed by a UE (e.g., any of UE 102, UE 103, UE 104, and UE 105 illustrated and shown in FIG. 1). Although described with respect to a UE, it should be understood that other devices may be configured to perform a method similar to that of FIG. 2.

In the exemplary method 200 as shown in FIG. 2, in operation 201, a UE (e.g., UE 103 illustrated and shown in FIG. 1) transmits a control signal to another UE (e.g., UE 101 illustrated and shown in FIG. 1). The control signal indicates resource(s) reserved for the UE, i.e., the UE's reserved resource(s). For example, the control signal is a PSCCH transmission including SCI.

In operation 202, the UE (e.g., UE 103 illustrated and shown in FIG. 1) receives a resource conflict indicator from the abovementioned another UE (e.g., UE 101 illustrated and shown in FIG. 1). The resource conflict indicator indicates that there is a resource conflict between resource(s) reserved for the UE and resource(s) reserved for an additional UE (e.g., UE 105 illustrated and shown in FIG. 1).

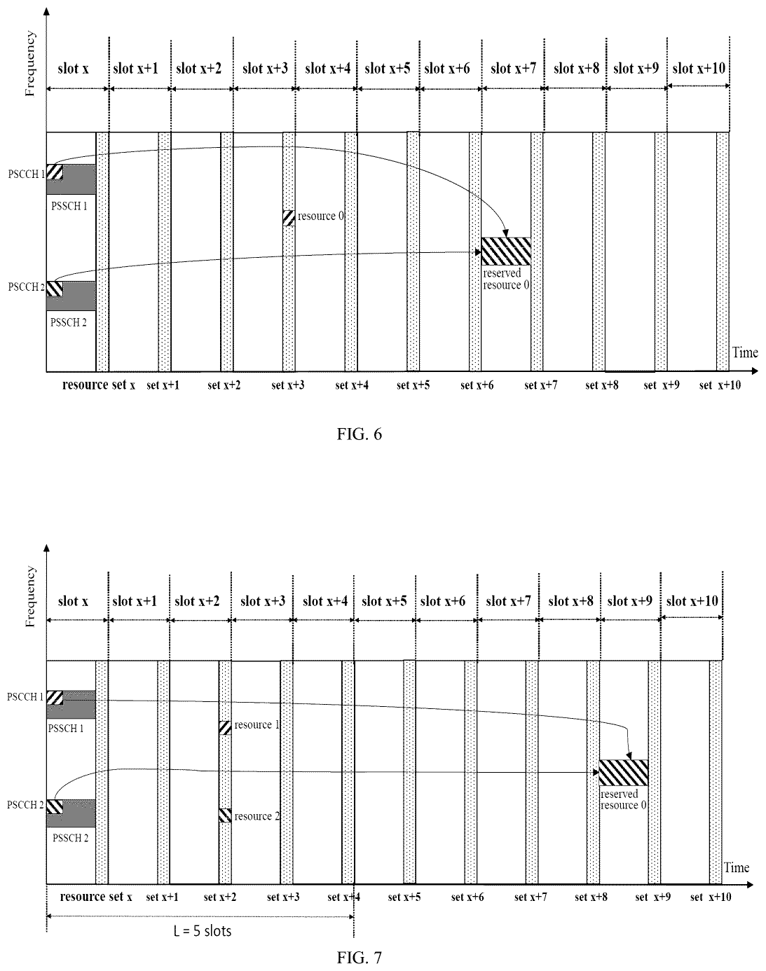

According to some embodiments, the UE (e.g., UE 103 illustrated and shown in FIG. 1) triggers a resource reselection procedure for a future transmission to be transmitted on a UE's reserved resource which relates to the resource conflict. The UE may also exclude the UE's reserved resource relating to the resource conflict. For example, the UE's reserved resource is excluded from a candidate resource set of the UE. According to some other embodiments, the UE drops a future transmission to be transmitted on the UE's reserved resource relating to the resource conflict. A specific example is described in FIG. 6.

Details described in the embodiments as illustrated and shown in FIGS. 1 and 3-13, especially, contents related to a resource conflict indicator and a resource for transmitting a resource conflict indicator, are applicable for the embodiments as illustrated and shown in FIG. 2. Moreover, details described in the embodiments of FIG. 2 are applicable for all the embodiments of FIGS. 1 and 3-13.

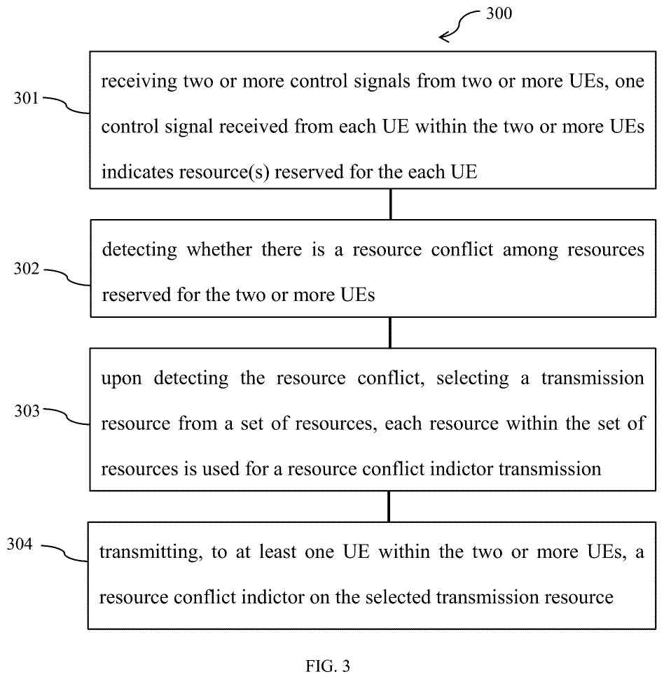

FIG. 3 illustrates an exemplary flow chart of a method for transmitting a resource conflict indicator on a transmission resource according to some embodiments of the present application.

The embodiments of FIG. 3 may be performed by a UE (e.g., UE 101 illustrated and shown in FIG. 1). In some cases, the UE may function as a coordination UE. Although described with respect to a UE, it should be understood that other devices may be configured to perform a method similar to that of FIG. 3.

In the exemplary method 300 as shown in FIG. 3, in operation 301, a UE (e.g., UE 101 illustrated and shown in FIG. 1) receives two or more control signals from two or more UEs (e.g., any of UE 102 to UE 105 illustrated and shown in FIG. 1). One control signal received from each UE within these two or more UEs indicates resource(s) reserved for each UE.

In operation 302, the UE detects whether there is a resource conflict among resources reserved for these two or more UEs. In operation 303, upon detecting the resource conflict, the UE selects a transmission resource from a set of resources. Each resource within the set of resources is used for a resource conflict indictor transmission.

This set of resources for a resource conflict indictor transmission may also be named as “a set of resource conflict indicator resources”, “a set of resource conflict indication resources”, “a set of resources for resource conflict indication”, “a transmission resource set for a resource conflict indicator”, “a resource set for transmitting a resource conflict indicator”, “a resource set for a resource conflict indicator transmission”, or the like. As described above, a resource conflict indicator transmission resource may also be named as a resource for transmitting a resource conflict indicator, a transmission resource for a resource conflict indicator, a resource for a resource conflict indicator transmission, or the like.

In operation 304, the UE transmits, to at least one UE within these two or more UEs, a resource conflict indictor on the selected transmission resource. In some embodiments, the UE transmits a resource conflict indictor to only one UE within these two or more UEs, when resource(s) reserved for the only one UE is in conflict with resource(s) reserved for another UE within these two or more UEs. In some other embodiments, the UE transmits a resource conflict indictor to all UEs relating to a resource conflict within these two or more UEs. The resource conflict indicator may represent ‘NACK’. For example, the resource conflict indicator may be with 1 bit, wherein value ‘0’ of the bit indicates ‘NACK’.

For instance, referring back to FIG. 1, according to the embodiments of FIG. 3, UE 101 may receive three control signals including SCI from UE 102, UE 103, and UE 105, and each of these three control signals indicates reserved resource(s) for each of these three UEs, respectively. UE 101 detects whether there is a resource conflict among resources reserved for UE 102, UE 103, and UE 105. If UE 101 detects a resource conflict, UE 101 may select a transmission resource from a set of resources for resource conflict indictor transmissions. Then, UE 101 may transmit, to at least one UE within UE 102, UE 103, and UE 105, a resource conflict indictor on the selected transmission resource. In an example, UE 101 transmits a resource conflict indictor to only one UE, e.g., UE 102, to indicate UE 102 to trigger a resource reselection or drop an intended transmission on the conflicted reserved resource(s). In a further example, UE 101 transmits a resource conflict indictor to two UEs, e.g., UE 102 and UE 103, whose reserved resources are in conflict with each other, to indicate these two UEs to trigger a resource reselection or drop the intended transmission on the conflicted reserved resource(s). In another example, UE 101 transmits a resource conflict indictor to three UEs, e.g., UE 102, UE 103, and UE 105, whose reserved resources are in conflict with each other.

In some embodiments of FIG. 3, during detecting whether there is a resource conflict in operation 302, the UE (e.g., UE 101 illustrated and shown in FIG. 1) may check whether at least one of following resource conflict detection conditions is fulfilled, i.e., Conditions 1-3. In an embodiment, if at least one of Conditions 1-3 is fulfilled, the UE determines that a resource conflict is detected. In a further embodiment, only all Conditions 1-3 are fulfilled, the UE determines that a resource conflict is detected.

Condition 1: the UE detects whether there is resource overlapping between resources reserved for the two or more UEs. In some embodiments, upon detecting following Case 1 or Case 2, the UE considers that there is resource overlapping between reserved resources for UEs and a resource conflict detection condition is fulfilled.

Case 1: if a higher layer parameter allows only one resource to be reserved (e.g., sl-MaxNumPerReserve=2), two UEs each reserves only one resource, while resources reserved by these two UEs are partial or fully overlapped in frequency domain in one slot. As specified in 3GPP standard documents, sl-MaxNumPerReserve=2 represents that there is one current resource and maximum one future reserved resource is allowed to be reserved; and sl-MaxNumPerReserve=3 represents that there is one current resource and maximum two future reserved resources are allowed to be reserved.

Case 2: if a higher layer parameter allows maximum two resources to be reserved (e.g., sl-MaxNumPerReserve=3):
(1) In one alternative, if UE-1 (e.g., UE 102 illustrated and shown in FIG. 1) reserves two resources and UE-2 (e.g., UE 104 illustrated and shown in FIG. 1) reserves only one resource, one resource within two resources reserved by UE-1 is partial or fully overlapped with the only one resource reserved by UE-2 in frequency domain in one slot.
(2) In a further alternative, both UEs reserve two resources. In an example, at least one resource within two resources reserved by UE-1 is partial or fully overlapped with both resources reserved by UE-2 in frequency domain in one slot. In a further example, both resources reserved by UE-1 are partial or fully overlapped with both resources reserved by UE-2 in frequency domain.

Condition 2: the UE detects whether a time gap between each two control signals of the received control signals is equal to or less than a maximum time gap value. The maximum time gap value may be marked as “L”. With reference to FIG. 1, UE 101 may receive two or more SCI signals with resource reservation with the maximum time gap L. Specific examples are described in FIGS. 7-9 and 11-13.

According to some embodiments, in Condition 2, a value of the maximum time gap L may be determined by: a resource reservation processing time; and/or a resource selection processing time. For example, the value of L is computed as a sum of the resource reservation processing time and the resource selection processing time. According to some embodiments, if two UEs have different processing delay capabilities, each of these two UEs may indicate a value of the corresponding processing delay or a value of L, for example, each UE indicates a value of L in SCI.

In an embodiment, the value of L is determined by a processing delay including resource reservation processing delay (T_{proc,0}) and/or a resource selection processing delay (T_{proc,1}). For example, L is a sum of T_{proc,0} and T_{proc,1}. T_{proc,0} may also be marked as T_{proc,0}^{SL}. T_{proc,1} may also be marked as T_{proc,1}^{SL} or T₃. According to 3GPP standard document TS38.214, T_{proc,0}^{SL} depending on sub-carrier spacing is specified in Table 8.1.4-1 and T_{proc,1}^{SL} depending on sub-carrier spacing is specified in Table 8.1.4-2 as follows.

TABLE 8.1.4-1
T_{proc, 0}^{SL} depending on sub-carrier spacing

| | T_{proc, 0}^{SL} |
|---|---|
| μ_{SL} | [slots] |
| 0 | 1 |
| 1 | 1 |
| 2 | 2 |
| 3 | 4 |

TABLE 8.1.4-2:
T_{proc, 1}^{SL} depending on sub-carrier spacing

| | T_{proc, 1}^{SL} |
|---|---|
| μ_{SL} | [slots] |
| 0 | 3 |
| 1 | 5 |
| 2 | 9 |
| 3 | 17 |

Condition 3: the UE detects whether all reference signal received power (RSRP) measurement results of the two or more UEs are above a threshold. In some embodiments, upon determining that all RSRP measurement results of the two or more UEs are above a threshold, the UE considers that a resource conflict detection condition is fulfilled.

According to some embodiments, the set of resource conflict indicator resources in operation 303 are associated with the received two or more control signals, e.g., two or more SCIs. In an embodiment, a time domain location of “a resource within the set of resource conflict indicator resources” is after a time domain location of “a corresponding control signal within the two or more control signals”, and the resource within the set is associated with the corresponding control signal.

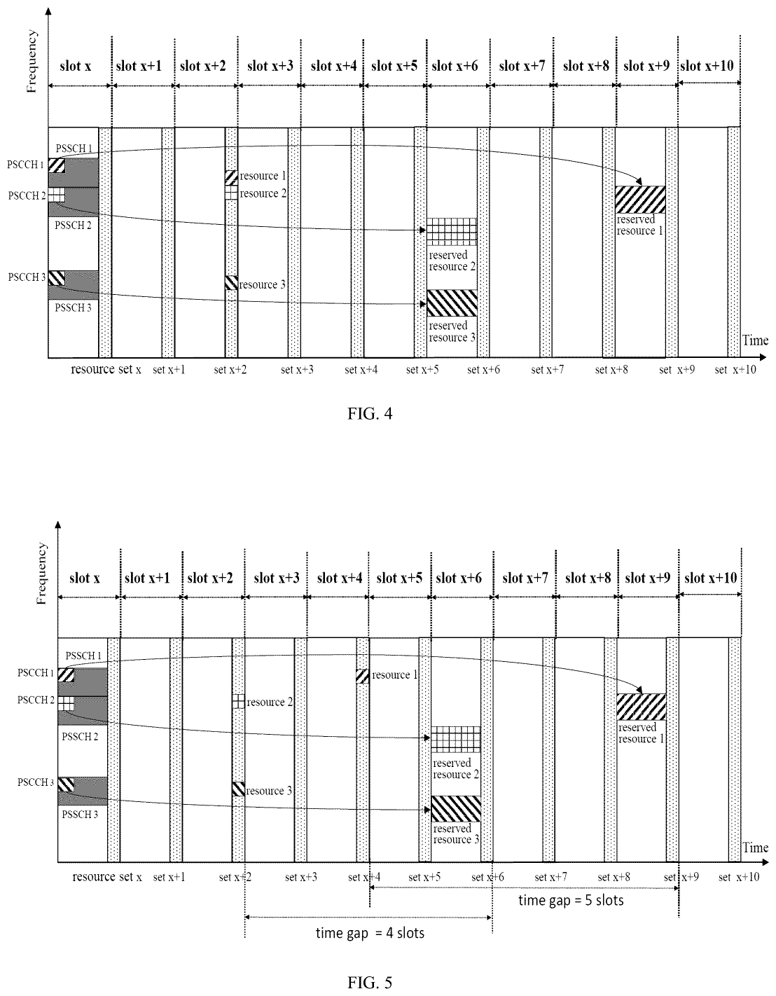

For instance, “a resource within the set of resource conflict indicator resources” is associated with a location of PSCCH which transmits SCI. The SCI is used for reserving resource(s) in time and/or frequency domains. The resource may be located after the location of PSCCH which transmits SCI. Specific examples are described in FIGS. 4-13, which show several sets of resource conflict indicator resources, i.e., “resource set x” to “resource set x+10”.

In a further embodiment, a time domain location of “a resource within the set of resource conflict indicator resources” may be determined based on a mapping rule relating to a corresponding control signal within the received two or more control signals, and the resource within the set is associated with the corresponding control signal.

In some embodiments, several sets of resource conflict indicator resources may be periodically configured in time domain. A time gap in time domain between a resource within a set of resource conflict indicator resources and a corresponding control signal may be configured. For instance, higher layer parameters can configure a period of a set of resource conflict indicator resources and a time gap between a resource within the set and a corresponding control signal, e.g., the same as PSFCH resource configuration. In an embodiment, mapping rule(s) between a resource conflict indicator transmission resource and a location of PSCCH which transmits the SCI can be the same as PSFCH resources mapping rule(s) defined in 3GPP Release 16 sidelink standard document. According to agreements of 3GPP standard document TS38.331, PSFCH configurations may be as follows.

| | |
|---|---|
| sl-PSFCH-Period-r16 | ENUMERATED {sl0, sl1, sl2, sl4} |
| sl-MinTimeGapPSFCH-r16 | ENUMERATED {sl2, sl3} |

According to some other embodiments, the set of resource conflict indicator resources in operation 303 are associated with the reserved resources for the two or more UEs. In an embodiment, a time domain location of a resource within the set of resources is before a time domain location of a reserved resource within the reserved resources for the two or more UEs, and wherein the resource is associated with the reserved resource.

In some embodiments, during selecting the transmission resource from the set of resources, the UE (e.g., UE 101 illustrated and shown in FIG. 1) further determines whether a time gap between “a resource within the set of resources” and “a reserved resource within the reserved resources for the two or more UEs” is equal to or greater than a time gap threshold (e.g., which is marked as “T”). If the UE determines that the time gap is equal to or greater than the time gap threshold, i.e., >=T, the UE selects the resource within the set of resources as the selected transmission resource. The time gap between the resource for a resource conflict indicator transmission and the reserved resource can be configured or specified. For instance, if a resource reselection procedure is triggered if one UE receives the resource conflict indicator, the time gap can be specified as T or be configured to be >=T.

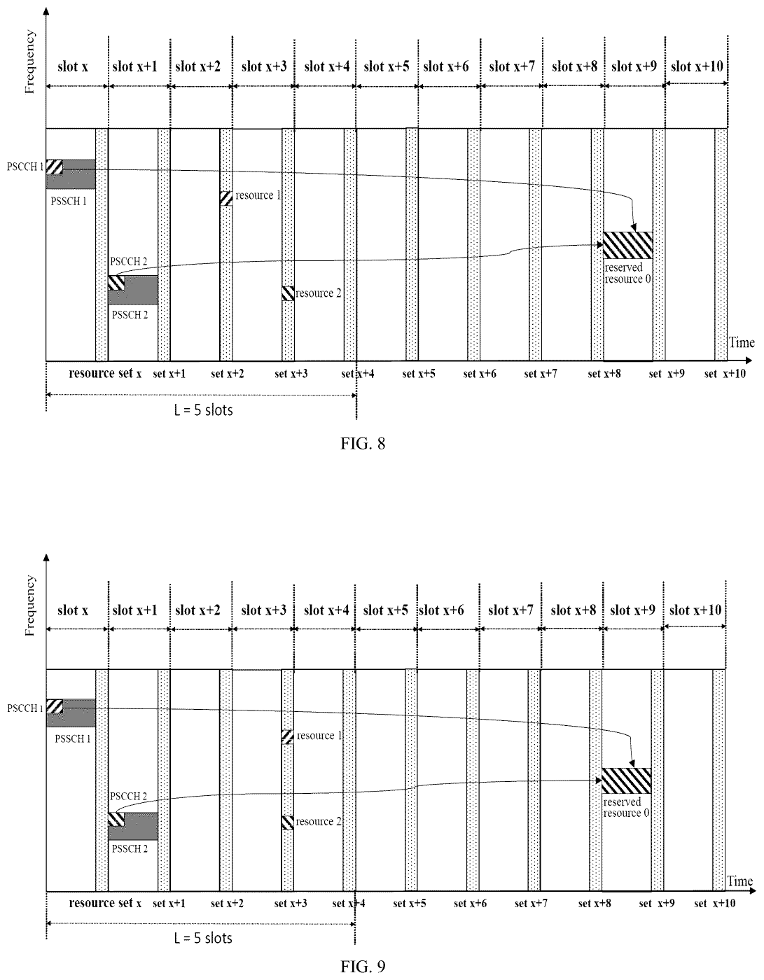

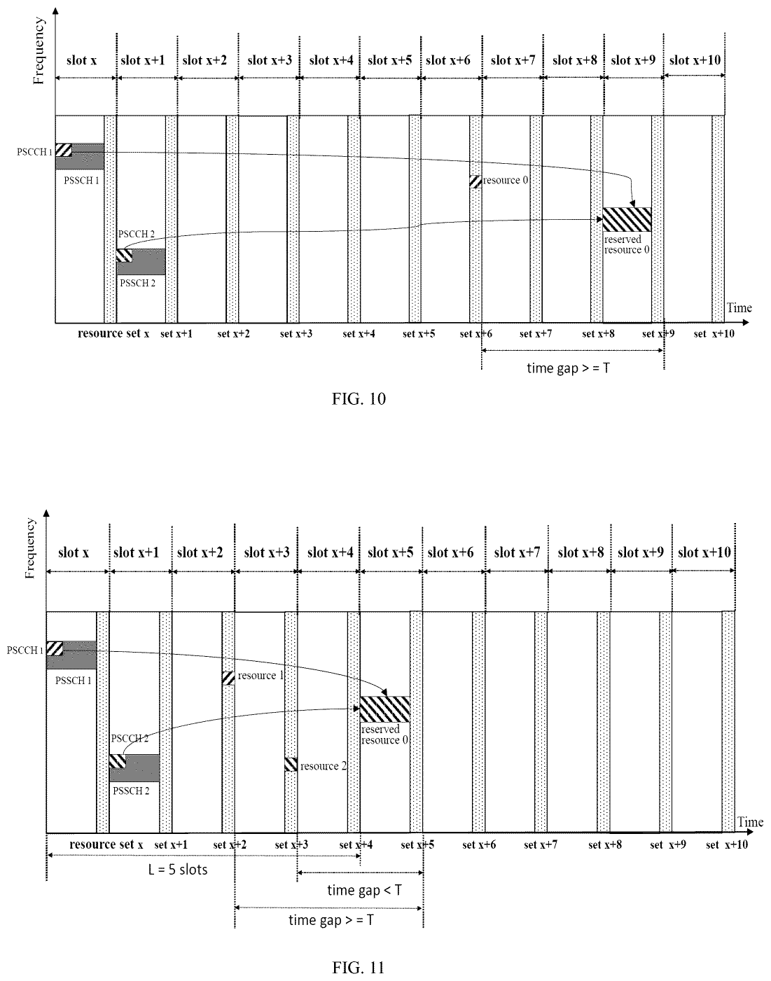

In some embodiments, the UE (e.g., UE 101 illustrated and shown in FIG. 1) selects the transmission resource (i.e., a resource conflict indicator transmission resource) from the set of resource conflict indication resources by performing at least one of Options 1-6.
(1) Option 1: selecting the transmission resource according to a priority filed value included in a control signal within the received two or more control signals. Specifically, the UE may select the transmission resource according to a priority filed value included in the associated SCI. A priority filed value in SCI is specified in 3GPP standard document TS38.212 section 8.3.1.1, which refers to 3GPP standard document TS23.287 section 5.4.3.3.
   a) For example, the UE selects the transmission resource associated with a control signal including a higher priority filed value within the received two or more control signals. As specified in 3GPP standard document TS38.212, a higher priority field value indicated in SCI means a lower priority. That is to say, the UE may select the transmission resource associated with a lower priority included in the received SCI, i.e., a higher priority filed value included in the received SCI. Specific examples are described in FIGS. 7-9.
(2) Option 2: selecting the transmission resource according to a time domain location of each resource within the set of resources. Specifically, the UE may select the transmission resource having an earliest time domain location within the set of resources. A specific example is described in FIG. 8.
(3) Option 3: selecting the transmission resource according to a time gap between “a resource within the set of resources” and “an associated reserved resource within resources reserved for the two or more UEs”. Specifically, the UE may select a transmission resource having a largest time gap from the associated reserved resource within resources reserved for the two or more UEs. Specific examples are described in FIGS. 10 and 11.
(4) Option 4: selecting the transmission resource according to a sub-channel total number of a reserved resource within resources reserved for the two or more UEs. Specifically, the UE selects the transmission resource according to a total number of reserved sub-channels. For example, the UE may select a resource associated with a reserved resource having a least sub-channel total number within the reserved resources for the two or more UEs.
   a) Referring back to FIG. 1, UE 102 and UE 103 may reserve different number of sub-channels. If UE 102 has a smaller number of sub-channels, UE 101 may select the transmission resource associated with UE 102, because UE 102 with a smaller number of reserves sub-channels may have a higher opportunity to select new resource during its resource reselection. Alternatively, if UE 103 has a smaller number of sub-channels, UE 101 may select the transmission resource associated with UE 103.
(5) Option 5: selecting the transmission resource according to a reserved resource total number indicated by a control signal within the two or more control signals. Specifically, the UE may select a resource associated with a control signal having a least reserved resource total number within the two or more control signals. A specific example is described in FIG. 12.
(6) Option 6: selecting the resource according to a power restriction of the UE (e.g., UE 101 illustrated and shown in FIG. 1). Specifically, the UE may select a resource not to be dropped based on the power restriction of the UE. A specific example is described in FIG. 8.

In some cases, if a UE reserves two resources while only one resource is overlapped with resources reserved by another UE, a resource conflict indicator of one bit cannot distinguish on which reserved resource a resource conflict will happen. According to some embodiments, a resource conflict indicator of two bits can be transmitted to a UE, to indicate to the UE to trigger a resource reselection procedure or drop the intended transmission on the conflicted reserved resource.

For example, in a case that UE-1 (e.g., UE 102 as illustrated and shown in FIG. 1) receives a resource conflict indicator including two bits, ‘00’ means that the first resource reserved by UE-1 is overlapped with resource(s) reserved by UE-2 (e.g., UE 103 as illustrated and shown in FIG. 1), ‘01’ means that the second resource reserved by UE-1 is overlapped with the resource(s) reserved by UE-2, and ‘10’ means that both resources reserved by UE-1 are overlapped with the resource(s) reserved by UE-2. Different values of each bit in the resource conflict indicator may be used to mean different resource conflict cases in different embodiments.

Details described in the embodiments as illustrated and shown in FIGS. 1, 2, and 4-13, especially, contents related to a resource conflict indicator and a resource for transmitting a resource conflict indicator, are applicable for the embodiments as illustrated and shown in FIG. 3. Moreover, details described in the embodiments of FIG. 3 are applicable for all the embodiments of FIGS. 1, 2, and 4-13.

FIG. 4 illustrates an exemplary diagram for sets of resource conflict indicator transmission resources according to some embodiments of the present application.

The embodiments of FIG. 4 show 11 time slots in time domain for illustrative purpose, i.e., “slot x”, “slot x+1”, “slot x+2”, “slot x+3”, “slot x+4”, “slot x+5”, “slot x+6”, “slot x+7”, “slot x+8”, “slot x+9”, and “slot x+10”. Although a specific number of slots are depicted in FIG. 4, it is contemplated that any total number of slots may be configured to the embodiments of FIG. 4 in different cases.

In the embodiments of FIG. 4, there may be one or more sets of resource conflict indicator transmission resources. A set of resource conflict indicator transmission resources may include one or more resources for transmitting a resource conflict indictor. The embodiments of FIG. 4 show 11 sets of resource conflict indicator transmission resources in “slot x” to “slot x+10”, respectively, i.e., “resource set x”, “resource set x+1”, “resource set x+2”, “resource set x+3”, “resource set x+4”, “resource set x+5”, “resource set x+6”, “resource set x+7”, “resource set x+8”, “resource set x+9”, and “resource set x+10”. Resource(s) in each of these resource sets (i.e., “resource set x” to “resource set x+10”) may be used for transmitting a resource conflict indictor when there is a resource conflict between resources reserved for two or more UEs.

As shown in FIG. 4, three PSSCHs are transmitted in different sub-channels in frequency domain in the same slot, i.e., “slot x”. PSSCH 1 is associated with PSCCH 1, PSSCH 2 is associated with PSCCH 2, and PSSCH 3 is associated with PSCCH 3. Each of PSCCH 1, PSCCH 2, and PSCCH 3 may transmit SCI for three different UEs (e.g., three UEs within UE 102, UE 103, UE 104 and UE 105 as illustrated and shown in FIG. 1). As shown in FIG. 4, PSCCH 1 is used for reserving “reserved resource 1” in “slot x+9”. PSCCH 2 is used for reserving “reserved resource 2” in “slot x+6”. PSCCH 3 is used for reserving “reserved resource 3” in “slot x+6”.

According to some embodiments of FIG. 4, a resource conflict indicator transmission resource is associated with a location of PSCCH which transmits SCI. The SCI is used for reserving resource(s). For instance, a time domain location of a resource conflict indicator transmission resource may be determined based on a time domain location of SCI In these embodiments of FIG. 4, three PSCCHs for three UEs are transmitted in the same “slot x”, and thus three different resource conflict indicator transmission resources may also be located in the same resource set in the same slot, e.g., “resource set x+2” in “slot x+2” as shown in FIG. 4. In other words, in these embodiments of FIG. 4, a UE may select three resources in the same “resource set x+2” in “slot x+2” to transmit three resource conflict indictors associated with “reserved resource 1” in “slot x+9”, “reserved resource 2” in “slot x+6”, and “reserved resource 3” in “slot x+6”, respectively.

In particular, “resource set x+2” in “slot x+2” includes three resource conflict indicator transmission resources. As show in FIG. 4, “resource 1” may be used for transmitting a resource conflict indictor associated with PSCCH 1 with “reserved resource 1” in “slot x+9”, “resource 2” may be used for transmitting a resource conflict indictor associated with PSCCH 2 with “reserved resource 2” in “slot x+6”, and “resource 3” may be used for transmitting a resource conflict indictor associated with PSCCH 3 with “reserved resource 3” in “slot x+6”.

A resource conflict indictor associated with PSCCH with a reserved resource in a slot means that a UE may transmit this resource conflict indictor when this reserved resource has a resource conflict with any other reserved resource in time and frequency domains. For instance, a UE may transmit a resource conflict indictor on “resource 1” when “reserved resource 1” in “slot x+9” has any resource conflict with any other reserved resource in time and frequency domains.

According to some other embodiments, a UE may select different resources in different resource sets to transmit resource conflict indictors for different UEs. More details will be illustrated in the following text in combination with FIGS. 5-13.

Details described in the embodiments as illustrated and shown in FIGS. 1-3 and 5-13, especially, contents related to a resource conflict indicator and a resource for transmitting a resource conflict indicator, are applicable for the embodiments as illustrated and shown in FIG. 4. Moreover, details described in the embodiments of FIG. 4 are applicable for all the embodiments of FIGS. 1-3 and 5-13.

FIG. 5 illustrates a further exemplary diagram for sets of resource conflict indicator transmission resources according to some embodiments of the present application.

The same as FIG. 4, FIG. 5 show 11 slots in time domain (i.e., “slot x” to “slot x+10”), slot x includes three PSSCHs in frequency domain (i.e., PSSCH 1 which is associated with PSCCH 1, PSSCH 2 which is associated with PSCCH 2, and PSSCH 3 which is associated with PSCCH 3), and three PSCCHs are used for reserving three reserved resources (i.e., “reserved resource 1” in slot x+9, “reserved resource 2” in slot x+6, and “reserved resource 3” in slot x+6).

Different from FIG. 4, in the embodiments of FIG. 5, resource conflict indicator transmission resources are associated with locations of resources reserved for different UEs. For instance, a time domain location of a resource conflict indicator transmission resource may be determined based on a time domain location of a reserved resource. In the embodiments of FIG. 5, three resources reserved for three UEs are transmitted in different slots, and thus locations of three resources for transmitting three resource conflict indictors may be selected from different slots. In particular, as shown in FIG. 5, three resources for transmitting three resource conflict indictors are selected from different resource sets based on locations of three reserved resources.

The embodiments of FIG. 5 assume that a time gap threshold T is configured to be 4 slots, i.e., T=4 slots. If a UE determines that a time gap between “a resource within a set of resource conflict indicator resources” and “a reserved resource within resources reserved for UE(s)” is equal to or greater than the time gap threshold T, i.e., the time gap >=T, the UE may select “the resource within the set of resource conflict indicator resources” as the selected transmission resource, to transmit a resource conflict indictor.

As shown in FIG. 5, based on “T=4 slots” and “reserved resource 1” in slot x+9, a UE determines that a time gap between “slot x+4” and “slot x+9” equals to 5 slots, which is greater than the configured time gap threshold T, and then, the UE may select “resource 1” in “slot x+4” to transmit a resource conflict indictor associated with “reserved resource 1” in slot x+9.

Based on “T=4 slots” and both “reserved resource 2” and “reserved resource 3” in slot x+6, both “resource 2” and “resource 3” in slot x+2 may be used for transmitting resource conflict indictors associated with “reserved resource 2” and “reserved resource 3”, respectively, because a time gap between slot x+2 and slot x+6 is 4 slots, which is equal to the configured time gap threshold T. That is to say, the UE may select two resources from “resource set x+2” in slot x+2 to transmit two resource conflict indictors associated with “reserved resource 2” and “reserved resource 3” in slot x+6, respectively.

Details described in the embodiments as illustrated and shown in FIGS. 1-4 and 6-13, especially, contents related to a resource conflict indicator and a resource for transmitting a resource conflict indicator, are applicable for the embodiments as illustrated and shown in FIG. 5. Moreover, details described in the embodiments of FIG. 5 are applicable for all the embodiments of FIGS. 1-4 and 6-13.

FIG. 6 illustrates another exemplary diagram for sets of resource conflict indicator transmission resources according to some embodiments of the present application.

The same as FIGS. 4 and 5, the embodiments of FIG. 6 show the same slot configurations, i.e., “slot x” to “slot x+10”, and the same resource set configurations, i.e., “resource set x” to “resource set x+10”. Similar to FIGS. 4 and 5, in the embodiments of FIG. 6, two UEs (e.g., UE 104 and UE 105 as illustrated and shown in FIG. 1) transmit two PSSCHs in different sub-channels in frequency domain in the same “slot x”, i.e., PSSCH 1 which is associated with PSCCH 1, and PSSCH 2 which is associated with PSCCH 2.

In the embodiments of FIG. 6, PSCCH 1 and PSCCH 2 are used for reserving the same reserved resource, i.e., “reserved resource 0” in slot x+7. That is to say, these two reserved resources are overlapped and a resource conflict will happen. In such case, if a UE (e.g., UE 101 as illustrated and shown in FIG. 1) has detected the resource conflict, the UE will transmit a resource conflict indictor on the associated resource.

According to some embodiments of FIG. 6, the UE may select a resource conflict indicator transmission resource based on a time domain location of a reserved resource as described in the embodiments of FIG. 5. Since two reserved resources associated with PSCCH 1 and PSCCH 2 are overlapped in the same slot (i.e., “reserved resource 0” in “slot x+7”), a UE will select the same resource conflict indicator transmission resource (e.g., “resource 0” in “slot x+3” as shown in FIG. 6) based on a time domain location of “reserved resource 0” in “slot x+7”.

For example, referring back to FIG. 1, UE 101 may select “resource 0” in “slot x+3” to transmit a resource conflict indicator for “reserved resource 0” in “slot x+7” upon detecting the resource conflict. After UE 104 and UE 105 receive the resource conflict indicator on the associated resource “resource 0”, both UE 104 and UE 105 may trigger a resource reselection procedure and/or drop the intended transmission on the reserved resource, i.e., “reserved resource 0”.

Details described in the embodiments as illustrated and shown in FIGS. 1-5 and 7-13, especially, contents related to a resource conflict indicator and a resource for transmitting a resource conflict indicator, are applicable for the embodiments as illustrated and shown in FIG. 6. Moreover, details described in the embodiments of FIG. 6 are applicable for all the embodiments of FIGS. 1-5 and 7-13.

FIG. 7 illustrates an additional exemplary diagram for sets of resource conflict indicator transmission resources according to some embodiments of the present application.

The same as FIG. 6, the embodiments of FIG. 7 show the same slot configurations (i.e., “slot x” to “slot x+10”) and the same resource set configurations (i.e., “resource set x” to “resource set x+10”). In the embodiments of FIG. 7, two UEs (e.g., UE 104 and UE 105 as illustrated and shown in FIG. 1) transmit two PSSCHs in different sub-channels in frequency domain in the same “slot x” (i.e., PSSCH 1 which is associated with PSCCH 1, and PSSCH 2 which is associated with PSCCH 2). PSCCH 1 and PSCCH 2 are used for reserving the same reserved resource (i.e., “reserved resource 0” in “slot x+7”).

The embodiments of FIG. 7 assume that the maximum time gap L is configured or computed as 5 slots. Since a time gap between two control signals (i.e., PSCCH 1 and PSCCH 2) is 0 slot, which is less than 5 slots, two UEs (e.g., UE 104 and UE 105 as illustrated and shown in FIG. 1) cannot monitor a resource conflict to each other. In such case, if a UE (e.g., UE 101 as illustrated and shown in FIG. 1) has detected a resource conflict between these two UEs, the UE will transmit a resource conflict indictor on the associated resource.

In the embodiments of FIG. 7, a UE may select a resource conflict indicator transmission resource according to a priority filed value indicated in the associated SCI as described in Option 1 of the embodiments of FIG. 3. For instance, UE-1 (e.g., UE 104 as illustrated and shown in FIG. 1) transmits SCI with resource reservation including a priority filed value p1 and UE-2 (e.g., UE 105 as illustrated and shown in FIG. 1) transmits SCI with resource reservation including a priority filed value p2, respectively. As specified in 3GPP standard document TS38.212, a higher priority field value indicated in SCI means a lower priority. In particular:
1) When p1>p2, which means that the SCI transmitted by UE-1 has a lower priority and the SCI transmitted by UE-2 has a higher priority, after a UE (e.g., UE 101 as illustrated and shown in FIG. 1) detects a resource conflict, the UE will select a resource conflict indicator transmission resource associated with the SCI transmitted by UE-1. That is, the UE will select “resource 1” associated with the SCI transmitted by UE-1 to transmit a resource conflict indicator to UE-1. After receiving the resource conflict indicator, UE-1 may trigger a resource reselection procedure and exclude the reserved resource from its candidate resources or drop the intended transmission on “reserved resource 0”.
2) When p2>p1, which means that the SCI transmitted by UE-1 has a higher priority and the SCI transmitted by UE-2 has a lower priority, after the UE detects a resource conflict, the UE will select a resource conflict indicator transmission resource associated with the SCI transmitted by UE-2. That is, the UE will select “resource 2” associated with the SCI transmitted by UE-2 to transmit a resource conflict indicator to UE-2. After receiving the resource conflict indicator, UE-2 may trigger a resource reselection procedure and exclude the reserved resource from its candidate resources or drop the intended transmission on “reserved resource 0”.
3) When p1=p2, which means that the SCI transmitted by UE-1 and the SCI transmitted by UE-2 have the same priority, after the UE detects a resource conflict, the UE may randomly select a resource conflict indicator transmission resource, e.g., either “resource 1” or “resource 2”, to either UE-1 or UE-2.

Details described in the embodiments as illustrated and shown in FIGS. 1-6 and 8-13, especially, contents related to a resource conflict indicator and a resource for transmitting a resource conflict indicator, are applicable for the embodiments as illustrated and shown in FIG. 7. Moreover, details described in the embodiments of FIG. 7 are applicable for all the embodiments of FIGS. 1-6 and 8-13.

FIG. 8 illustrates yet an additional exemplary diagram for sets of resource conflict indicator transmission resources according to some embodiments of the present application.

The same as FIG. 7, the embodiments of FIG. 8 show the same slot configurations (i.e., “slot x” to “slot x+10”), the same resource set configurations (i.e., “resource set x” to “resource set x+10”), and the same maximum time gap “L=5 slots”. Different from FIG. 7, in the embodiments of FIG. 8, two UEs (e.g., UE 104 and UE 105 as illustrated and shown in FIG. 1) transmit two PSSCHs in different slots. For example, UE 104 transmits PSSCH 1 which is associated with PSCCH 1 in “slot x”, and UE 105 transmits PSSCH 2 which is associated with PSCCH 2 in “slot x+1”. PSCCH 1 and PSCCH 2 are used for reserving the same reserved resource, i.e., “reserved resource 0” in “slot x+9”.

According to some embodiments of FIG. 8, a UE (e.g., UE 101 as illustrated and shown in FIG. 1) may select a resource conflict indicator transmission resource based on a time domain location of a location of PSCCH or PSSCH as described in the embodiments of FIG. 4. Since PSCCH 1 and PSCCH 2 are in the different slots, “resource 1” may be located in “resource set x+2” in “slot x+2”, and “resource 2” may be located in “resource set x+3” in “slot x+3”.

In these embodiments of FIG. 8, similar to the embodiments of FIG. 7, after a UE detects a resource conflict between two UEs, the UE may select a resource conflict indicator transmission resource (e.g., either “resource 1” or “resource 2”) according to a priority filed value indicated in the associated SCI in PSCCH 1 and PSCCH 2 as described in Option 1 of the embodiments of FIG. 3. Specifically, in these embodiments of FIG. 8, if UE-1 (e.g., UE 104 as illustrated and shown in FIG. 1) transmits SCI including a priority filed value p1 and UE-2 (e.g., UE 105 as illustrated and shown in FIG. 1) transmits SCI including a priority filed value p2, respectively, after a UE (e.g., UE 101 as illustrated and shown in FIG. 1) detects a resource conflict:
1) when p1>p2, the UE will select “resource 1” associated with the SCI transmitted by UE-1, to transmit a resource conflict indicator to UE-1;
2) when p2>p1, the UE will select “resource 2” associated with the SCI transmitted by UE-2, to transmit a resource conflict indicator to UE-2; and
3) when p1=p2, the UE may randomly select a resource conflict indicator transmission resource, e.g., either “resource 1” or “resource 2”, to either UE-1 or UE-2.

According to some further embodiments of FIG. 8, a UE (e.g., UE 101 as illustrated and shown in FIG. 1) may select a resource conflict indicator transmission resource based on a time domain location of a location of PSCCH or PSSCH as described in Option 2 of the embodiments of FIG. 3. In particular, if two or more indicator resources are located in different slots, a UE (e.g., UE 101 as illustrated and shown in FIG. 1) selects the first indicator resource in time domain for a resource conflict indicator transmission. Then, the UE transmits a resource conflict indicator in the first indicator resource within two or more indicator resources, to reduce the inter-UE coordination delay. As shown in FIG. 8, “resource 1” in slot x+2 is before “resource 2” in slot x+3 in time domain, and thus “resource 1” is the first indicator resource in time domain, and the UE will select “resource 1” to transmit a resource conflict indicator.

According to some other embodiments of FIG. 8, a UE (e.g., UE 101 as illustrated and shown in FIG. 1) may select a resource conflict indicator transmission resource based on a time domain location of a location of PSCCH or PSSCH as described in Option 6 of the embodiments of FIG. 3. In particular, for each slot in FIG. 8, a UE may only select a part of resources for transmission due to a power restriction or the capability of the UE, e.g., by adopting a similar approach as PSFCH transmission selection procedure as defined in 3GPP Release 16 sidelink. If one resource within “resource 1” and “resource 2” will be dropped due to the power restriction or the capability of the UE, the UE will select the other resource which will not be dropped.

Details described in the embodiments as illustrated and shown in FIGS. 1-7 and 9-13, especially, contents related to a resource conflict indicator and a resource for transmitting a resource conflict indicator, are applicable for the embodiments as illustrated and shown in FIG. 8. Moreover, details described in the embodiments of FIG. 8 are applicable for all the embodiments of FIGS. 1-7 and 9-13.

FIG. 9 illustrates yet an additional exemplary diagram for sets of resource conflict indicator transmission resources according to some embodiments of the present application.

The same as FIG. 8, the embodiments of FIG. 9 show the same slot configurations (i.e., “slot x” to “slot x+10”), the same resource set configurations (i.e., “resource set x” to “resource set x+10”), and the same maximum time gap L=5 slots. The same as FIG. 8, in the embodiments of FIG. 9, two UEs transmit two PSSCHs in different slots (i.e., PSSCH 1 which is associated with PSCCH 1 in “slot x”, and PSSCH 2 which is associated with PSCCH 2 in “slot x+1”), and PSCCH 1 and PSCCH 2 are used for reserving the same “reserved resource 0” in “slot x+9”.

According to some embodiments of FIG. 9, the UE may select a resource conflict indicator transmission resource based on a time domain location of a reserved resource as described in the embodiments of FIG. 5. Since two reserved resources associated with PSCCH 1 and PSCCH 2 are overlapped in the same slot (i.e., “reserved resource 0” in “slot x+9”), “resource 1” and “resource 2” may be located in the same resource set in the same slot, e.g., “resource set x+3” in “slot x+3” as shown in FIG. 9.

In these embodiments of FIG. 9, similar to the embodiments of FIGS. 7 and 8, after a UE detects a resource conflict between two UEs, the UE may select a resource conflict indicator transmission resource (e.g., either “resource 1” or “resource 2”) according to a priority filed value indicated in the associated SCI in PSCCH 1 and PSCCH 2 as described in Option 1 of the embodiments of FIG. 3.

Specifically, in these embodiments of FIG. 9, if UE-1 (e.g., UE 104 as illustrated and shown in FIG. 1) transmits SCI including a priority filed value p1 and UE-2 (e.g., UE 105 as illustrated and shown in FIG. 1) transmits SCI including a priority filed value p2, respectively, after a UE (e.g., UE 101 as illustrated and shown in FIG. 1) detects a resource conflict:
1) when p1>p2, the UE will select “resource 1” associated with the SCI transmitted by UE-1, to transmit a resource conflict indicator to UE-1;
2) when p2>p1, the UE will select “resource 2” associated with the SCI transmitted by UE-2, to transmit a resource conflict indicator to UE-2; and
3) when p1=p2, the UE may randomly select a resource conflict indicator transmission resource, e.g., either “resource 1” or “resource 2”, to either UE-1 or UE-2.

Details described in the embodiments as illustrated and shown in FIGS. 1-8 and 10-13, especially, contents related to a resource conflict indicator and a resource for transmitting a resource conflict indicator, are applicable for the embodiments as illustrated and shown in FIG. 9. Moreover, details described in the embodiments of FIG. 9 are applicable for all the embodiments of FIGS. 1-8 and 10-13.

FIG. 10 illustrates yet an additional exemplary diagram for sets of resource conflict indicator transmission resources according to some embodiments of the present application.

The same as FIGS. 8 and 9, the embodiments of FIG. 10 show the same slot configurations (i.e., “slot x” to “slot x+10”) and the same resource set configurations (i.e., “resource set x” to “resource set x+10”). The same as FIGS. 8 and 9, in the embodiments of FIG. 10, UE-1 and UE-2 (e.g., UE 104 and UE 105 as illustrated and shown in FIG. 1) transmit two PSSCHs in different slots (i.e., PSSCH 1 associated with PSCCH 1 in slot x, and PSSCH 2 associated with PSCCH 2 in slot x+1). PSCCH 1 and PSCCH 2 are used for reserving the same “reserved resource 0” in “slot x+9”.

The embodiments of FIG. 10 assume that a time gap threshold T is configured, for example, as 4 slots. In some embodiments of FIG. 10, according to Option 3 of the embodiments of FIG. 3, if a resource reselection trigger is supported, one additional resource conflict detection condition may be needed: a time gap between a resource conflict indicator transmission resource (e.g., “resource 0”) and the reserved resource (i.e., “reserved resource 0”) should be >=T. A time gap means a slot difference. If a UE (e.g., UE 101 as illustrated and shown in FIG. 1) determines that the time gap <T, the UE will not transmit a resource conflict indicator, because any of the two UEs cannot perform a resource reselection even if they receive a resource conflict indicator.

In particular, as shown in FIG. 10, when T is configured as 4 slots, a time gap between “slot x+6” and “slot x+9” is 4 slots, which is equals to T. Then, the UE may transmit a resource conflict indicator on “resource 0” upon detecting a resource conflict. Alternatively, when T is configured as 1 slot, 2 slots or 3 slots, a time gap between “slot x+6” and “slot x+9” is greater than T. Then, the UE may transmit a resource conflict indicator on “resource 0” upon detecting a resource conflict. However, if T is configured as 5 slots, a time gap between “slot x+6” and “slot x+9” is less than T, and then the UE will not transmit a resource conflict indicator on “resource 0” even if the UE detects a resource conflict.

In the embodiments of FIG. 10, if the abovementioned additional resource conflict detection condition is fulfilled (i.e., a time gap between a resource conflict indicator transmission resource and “reserved resource 0” >=T), and if UE-1 or UE-2 receives, from the UE, a resource conflict indicator on the associated resource (i.e., “resource 0”), UE-1 or UE-2 may trigger a resource reselection procedure and exclude the reserved resource from its candidate resources. Alternatively, UE-1 or UE-2 may drop the intended transmission on “reserved resource 0”.

Details described in the embodiments as illustrated and shown in FIGS. 1-9 and 11-13, especially, contents related to a resource conflict indicator and a resource for transmitting a resource conflict indicator, are applicable for the embodiments as illustrated and shown in FIG. 10. Moreover, details described in the embodiments of FIG. 10 are applicable for all the embodiments of FIGS. 1-9 and 11-13.

FIG. 11 illustrates yet an additional exemplary diagram for sets of resource conflict indicator transmission resources according to some embodiments of the present application.

The same as FIG. 8, the embodiments of FIG. 11 show the same slot configurations (i.e., “slot x” to “slot x+10”) the same resource set configurations (i.e., “resource set x” to “resource set x+10”), the same maximum time gap “L=5 slots”, and the same two PSSCHs in different slots (i.e., PSSCH 1 associated with PSCCH 1 in slot x, and PSSCH 2 associated with PSCCH 2 in slot x+1). Different from FIG. 8, in the embodiments of FIG. 11, PSCCH 1 and PSCCH 2 reserve the same reserved resource in “slot x+5”, i.e., “reserved resource 0”.

The same as FIG. 10, the embodiments of FIG. 11 assume that a time gap threshold T is configured, for example, as 4 slots. According to Option 3 of the embodiments of FIG. 3, some embodiments of FIG. 11 consider one additional resource conflict detection condition: a time gap between a resource conflict indicator transmission resource (e.g., “resource 1” or “resource 2”) and the reserved resource (i.e., “reserved resource 0”) should be >=T.

As shown in FIG. 11, a time gap between “resource 1” and “reserved resource 0” is 3 slots, and a time gap between “resource 2” and “reserved resource 0” is 2 slot. If T is configured as 3 slots, the time gap between “resource 2” and “reserved resource 0” is less than T, and the time gap between “resource 2” and “reserved resource 0” is equals to T; then, a UE (e.g., UE 101 as illustrated and shown in FIG. 1) will select “resource 1” to transmit a resource conflict indicator. That is, the UE selects a first resource for a resource conflict indicator transmission if a slot gap between the second resource and the reserved resource is <T.

Details described in the embodiments as illustrated and shown in FIGS. 1-10, 12, and 13, especially, contents related to a resource conflict indicator and a resource for transmitting a resource conflict indicator, are applicable for the embodiments as illustrated and shown in FIG. 11. Moreover, details described in the embodiments of FIG. 11 are applicable for all the embodiments of FIGS. 1-10, 12, and 13.

FIG. 12 illustrates yet an additional exemplary diagram for sets of resource conflict indicator transmission resources according to some embodiments of the present application.

The same as FIG. 7, the embodiments of FIG. 12 show the same slot configurations (i.e., “slot x” to “slot x+10”), the same resource set configurations (i.e., “resource set x” to “resource set x+10”), the same maximum time gap “L=5 slots”, and the same two PSSCHs in the same slot (i.e., PSSCH 1 associated with PSCCH 1 in slot x, and PSSCH 2 associated with PSCCH 2 in slot x). Different from FIG. 7, in the embodiments of FIG. 12, PSCCH 1 and PSCCH 2 reserve different reserved resources in different slots. Specifically, PSCCH 1 reserve two reserved resources including “reserved resource 1” in slot x+4 and “reserved resource 2” in slot x+9. PSCCH 2 reserve one reserved resource, i.e., “reserved resource 2” in slot x+9.

According to Option 5 of the embodiments of FIG. 3, in some embodiments of FIG. 12, if one UE (e.g., UE 104 as illustrated and shown in FIG. 1) reserves one resource and the other one UE (e.g., UE 105 as illustrated and shown in FIG. 1) reserves two resource, a UE (e.g., UE 101 as illustrated and shown in FIG. 1) may select a resource conflict indicator transmission resource associated with the SCI with only one resource reservation.

For example, in the embodiments of FIG. 12, PSCCH 1 transmitted by UE-1 reserves two resources (i.e., “reserved resource 1” in slot x+4 and “reserved resource 2” in slot x+9) while PSCCH 2 transmitted by UE-2 reserves only one resource (i.e., “reserved resource 2” in slot x+9), “resource 1” is associated with PSCCH 1, and “resource 2” is associated with PSCCH 2. Then, a UE will select a resource conflict indicator transmission resource associated with PSCCH 2 with only one resource reservation, i.e., the UE selects “resource 2” associated with PSCCH 2, to transmit a resource conflict indicator to UE-2.

Details described in the embodiments as illustrated and shown in FIGS. 1-11 and 13, especially, contents related to a resource conflict indicator and a resource for transmitting a resource conflict indicator, are applicable for the embodiments as illustrated and shown in FIG. 12. Moreover, details described in the embodiments of FIG. 12 are applicable for all the embodiments of FIGS. 1-11 and 13.

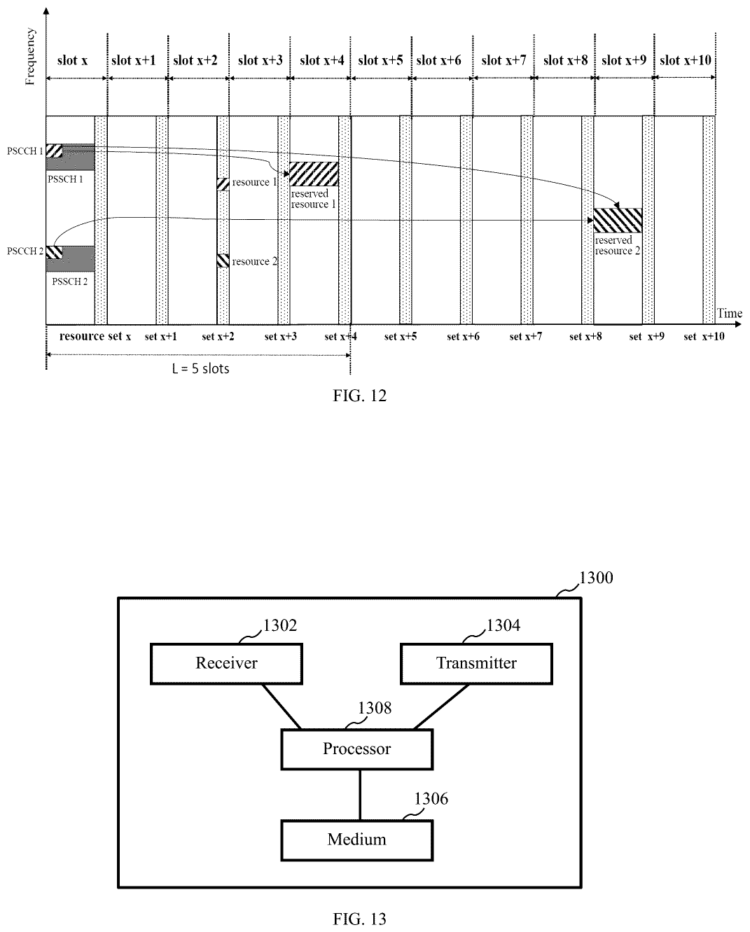

FIG. 13 illustrates an exemplary block diagram of an apparatus according to some embodiments of the present application. In some embodiments of the present application, the apparatus 1300 may be a UE, which can at least perform the method illustrated in any one of FIGS. 2-12.

As shown in FIG. 13, the apparatus 1300 may include at least one receiver 1302, at least one transmitter 1304, at least one non-transitory computer-readable medium 1306, and at least one processor 1308 coupled to the at least one receiver 1302, the at least one transmitter 1304, and the at least one non-transitory computer-readable medium 1306.

Although in FIG. 13, elements such as the at least one receiver 1302, the at least one transmitter 1304, the at least one non-transitory computer-readable medium 1306, and the at least one processor 1308 are described in the singular, the plural is contemplated unless limitation to the singular is explicitly stated. In some embodiments of the present application, the at least one receiver 1302 and the at least one transmitter 1304 are combined into a single device, such as a transceiver. In certain embodiments of the present application, the apparatus 1300 may further include an input device, a memory, and/or other components.

In some embodiments of the present application, the at least one non-transitory computer-readable medium 1306 may have stored thereon computer-executable instructions which are programmed to implement the operations of the methods, for example as described in view of any of FIGS. 2-12, with the at least one receiver 1302, the at least one transmitter 1304, and the at least one processor 1308.

Those having ordinary skills in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

What is claimed is:

1. A user equipment (UE) for wireless communication, comprising:
at least one memory; and
at least one processor coupled with the at least one memory and configured to cause the UE to:
receive two or more control signals from two or more UE, one control signal received from each UE of the two or more UE indicating one or more reserved resources for each UE;
detect whether there is a resource conflict among reserved resources for the two or more UE;
select, based at least in part on detection of the resource conflict, a transmission resource from a set of resources, each resource of the set of resources being usable for a resource conflict indictor transmission; and
transmit, to at least one UE of the two or more UE, a resource conflict indictor on the selected transmission resource.

2. The UE of claim 1, wherein to detect whether there is a resource conflict, the at least one processor is configured to cause the UE to:
detect whether there is resource overlapping between the reserved resources for the two or more UE;
detect whether a time gap between each two control signals of the two or more control signals is equal to or less than a maximum time gap value; and
detect whether reference signal received power (RSRP) measurement results of the two or more UE are above a threshold.

3. The UE of claim 2, wherein the maximum time gap value is determined by at least one of:
a resource reservation processing time; or
a resource selection processing time.

4. The UE of claim 3, wherein the maximum time gap value is a sum of the resource reservation processing time and the resource selection processing time.

5. The UE of claim 1, wherein the set of resources are associated with the two or more control signals.

6. The UE of claim 5, wherein a time domain location of a resource within the set of resources is after a time domain location of a control signal within the two or more control signals, and wherein the resource is associated with the control signal.

7. The UE of claim 1, wherein the set of resources are associated with the reserved resources for the two or more UE.

8. The UE of claim 7, wherein a time domain location of a resource within the set of resources is before a time domain location of a reserved resource within the reserved resources for the two or more UE, and wherein the resource is associated with the reserved resource.

9. The UE of claim 1, wherein to select the transmission resource from the set of resources, the at least one processor is configured to cause the UE to:
determine whether a time gap between a resource within the set of resources and a reserved resource within the reserved resources for the two or more UE is equal to or greater than a time gap threshold; and
select, in response to determining that the time gap is equal to or greater than the time gap threshold, the resource as the selected transmission resource.

10. The UE of claim 1, wherein to select the transmission resource from the set of resources, the at least one processor is configured to cause the UE to at least one of:
select the transmission resource according to a priority field value included in a control signal within the two or more control signals;
select the transmission resource according to a time domain location of each resource within the set of resources;
select the transmission resource according to a time gap between a resource within the set of resources and an associated reserved resource within the reserved resources for the two or more UE;
select the transmission resource according to a sub-channel total number of a reserved resource within the reserved resources for the two or more UE;
select the transmission resource according to a reserved resource total number indicated by a control signal within the two or more control signals; or
select the resource according to a power restriction of the at least one UE.

11. The UE of claim 10, wherein to select the transmission resource from the set of resources, the at least one processor is configured to cause the UE to:
select a resource associated with a control signal including a higher priority field value within the two or more control signals.

12. The UE of claim 10, wherein to select the transmission resource according to the time domain location, the at least one processor is configured to cause the UE to:
select a resource having an earliest time domain location within the set of resources.

13. A first user equipment (UE) for wireless communication, comprising:
at least one memory; and
at least one processor coupled with the at least one memory and configured to cause the first UE to:
transmit a control signal to a second UE, the control signal indicating one or more reserved resources for the first UE; and
receive a resource conflict indicator from the second UE, the resource conflict indicator indicating a resource conflict between the one or more reserved resources for the first UE and one or more reserved resources for a third UE.

14. The first UE of claim 13, wherein the at least one processor is configured to cause the first UE to:
trigger a resource reselection procedure for a transmission to be transmitted on a reserved resource for the first UE, wherein the reserved resource for the first UE relates to the resource conflict; and
exclude, from a candidate resource set of the first UE, the reserved resource for the first UE.

15. (canceled)

16. A processor for wireless communication, comprising:
at least one controller coupled with at least one memory and configured to cause the processor to:
receive two or more control signals from two or more UE, one control signal received from each UE of the two or more UE indicating one or more reserved resources for each UE;
detect whether there is a resource conflict among reserved resources for the two or more UE;
select, based at least in part on detection of the resource conflict, a transmission resource from a set of resources, each resource of the set of resources usable for a resource conflict indictor transmission; and
transmit, to at least one UE of the two or more UE, a resource conflict indictor on the selected transmission resource.

17. The processor of claim 16, wherein to detect whether there is a resource conflict, the at least one controller is configured to cause the processor to:
detect whether there is resource overlapping between the reserved resources for the two or more UE;
detect whether a time gap between each two control signals of the two or more control signals is equal to or less than a maximum time gap value; and
detect whether reference signal received power (RSRP) measurement results of the two or more UE are above a threshold.

18. The processor of claim 17, wherein the maximum time gap value is determined by at least one of:
a resource reservation processing time; or
a resource selection processing time.

19. The processor of claim 18, wherein the maximum time gap value is a sum of the resource reservation processing time and the resource selection processing time.

20. The processor of claim 19, wherein the set of resources are associated with the two or more control signals.

21. A processor for wireless communication, comprising:
at least one controller coupled with at least one memory and configured to cause the processor to:
transmit a control signal from a first UE to a second UE, the control signal indicating one or more reserved resources for the first UE; and
receive a resource conflict indicator from the second UE, the resource conflict indicator indicating a resource conflict between the one or more reserved resources for the first UE and one or more reserved resources for a third UE.
